(19) United States
(12) Patent Application Publication
(10) Pub. No.: US 2022/0231883 A1
(43) Pub. Date: Jul. 21, 2022

(54) Methods and Apparatus for Measurement and UE Antenna Selection

(71) Applicant: MEDIATEK INC., Hsin-Chu (TW)

(72) Inventors: Kuan-Hung Chou, Hsin-Chu (TW); Wenze Qu, Beijing (CN)

(21) Appl. No.: 17/181,606

(22) Filed: Feb. 22, 2021

(30) Foreign Application Priority Data
Jan. 21, 2021 (CN) 202110083909.8

(51) Int. Cl. H04L 25/02; H04W 24/10; H04B 17/309

(52) U.S. Cl. CPC H04L 25/0202; H04B 17/309; H04W 24/10

(57) ABSTRACT

Methods are proposed to derive measurement results for User Equipment (UE) antenna selection, beam selection, cell selection, handover, and radio resource management (RRM). First, UE determines its mobility state by using at least two of the following metrics: 1) Doppler information (e.g., from mobility detection gear, MD); 2) beam ping-pong rate, beam change rate, beam change per time period; and 3) moving speed and moving direction from an accelerometer sensor, rotation speed from a gyroscope, ambient magnetic field from a magnetic field sensor, and at least one active antenna set. Next, UE uses an averaging number that is adapted based on its mobility state to derive an average measurement result including at least one of RSRP, RSRQ, RSSI, IL, SNR, and SINR. Finally, UE performs antenna selection, beam selection, cell selection, or RRM based on the average measurement result and joint consideration.

### CROSS REFERENCE TO RELATED APPLICATIONS

This application claims priority under 35 U.S.C. 119 from Chinese Application Number CN 202110083909.8, filed on Jan. 21, 2021. The subject matter of which is incorporated herein by reference.

### TECHNICAL FIELD

The disclosed embodiments relate generally to wireless communication, and, more particularly, to method and apparatus for Reference Signal measurement and antenna selection in New Radio (NR) systems.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as User Equipments (UEs). The 3^{rd} generation partner project (3GPP) network normally includes a hybrid of 2G/3G/4G systems. The Next Generation Mobile Network (NGMN) board, has decided to focus the future NGMN activities on defining the end-to-end requirements for 5G New Radio (NR) systems.

Reference Signal Received Power (RSRP) and Reference Signal Received Quality (RSRQ) are key measurements of signal level and quality for LTE and NR networks. In cellular networks, when a UE moves from cell to cell and performs cell selection, reselection and handover, the UE needs to measure the signal strength and quality of the neighbor cells. While a measurement of channel quality represented by Signal to Interference plus Noise Ratio (SINR) is used for link adaptation along with packet scheduling, RSRP and RSRQ are needed for making handover decisions. Received Strength Signal Indicator (RSSI) measurements can be used to determine RSRP and RSRQ. RSSI measures the average total received power observed in OFDM symbols containing reference symbols in the measurement bandwidth over certain resource blocks. RSSI is measured over the entire bandwidth including noise, serving cell power and interference power.

Measurement results are frequently used for UE antenna selection, beam selection, cell selection, handover, and Radio Resource Management (RRM). When UE is in different mobility states, different mechanisms are desired for deriving measurement results. How to determining a UE mobility state is thus important. Metrics for determining UE mobility state and corresponding mechanisms for deriving measurement results is desired.

### SUMMARY

Methods are proposed to derive measurement results for UE antenna selection, beam selection, cell selection, handover, and Radio Resource Management (RRM). First, a UE determines its mobility state by using at least two of the following metrics: 1) Doppler information 2) beam ping-pong rate, beam change rate, beam change per time period; and 3) moving speed and moving direction from an accelerometer sensor, rotation speed from a gyroscope, ambient magnetic field from a magnetic field sensor, and at least one active antenna set. Next, the UE uses an averaging number that is adapted based on its mobility state to derive an average measurement result including at least one of RSRP, RSRQ, RSSI, IL, SNR and SINR. Finally, the UE performs antenna selection, beam selection, cell selection, or RRM based on the average measurement result and joint consideration.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a beamforming wireless communication system with enhanced methods for measurement and UE antenna selection in accordance with one novel aspect.

FIG. 2 shows simplified block diagrams of a UE and a BS in accordance with embodiments of the current invention.

FIG. 3 illustrates methods to adjust measurement samples and determine on UE antenna selection, beam selection, cell selection, or RRM in accordance with one novel aspect.

FIG. 4 illustrates a simplified block diagram of a UE for performing measurements and determining on UE antenna selection, beam selection, cell selection, or RRM in accordance with one novel aspect.

FIG. 5 illustrates certain issues with applying Doppler information to average RSRP measurement results and methods for improvement.

FIG. 6 illustrates embodiments of beam selection, cell selection, or RRM using MD plus beam Ping-Pong rate.

FIG. 7 illustrates embodiments of beam selection, cell selection, or RRM using MD plus beam change rate.

FIG. 8 illustrates embodiments of beam selection and cell selection using MD plus antenna selection, speed, and moving direction.

FIG. 9 illustrates a first embodiment of antenna selection using moving speeds and moving directions from an accelerometer sensor, rotation speeds from a gyroscope, ambient magnetic fields from a magnetic field sensor, and orientations of a UE.

FIG. 10 illustrates a second embodiment of antenna selection using moving speeds and moving directions from an accelerometer sensor, rotation speeds from a gyroscope, ambient magnetic fields from a magnetic field sensor, and orientations of a UE.

FIG. 11 is a flow chart of a method for UE beam selection, cell selection, or RRM in accordance with one novel aspect.

FIG. 12 is a flow chart of a method for UE antenna selection in accordance with one novel aspect.

FIG. 13 is a flow chart of a method for UE antenna selection in accordance with one novel aspect.

### DETAILED DESCRIPTION

Reference will now be made in detail to some embodiments of the invention, examples of which are illustrated in the accompanying drawings.

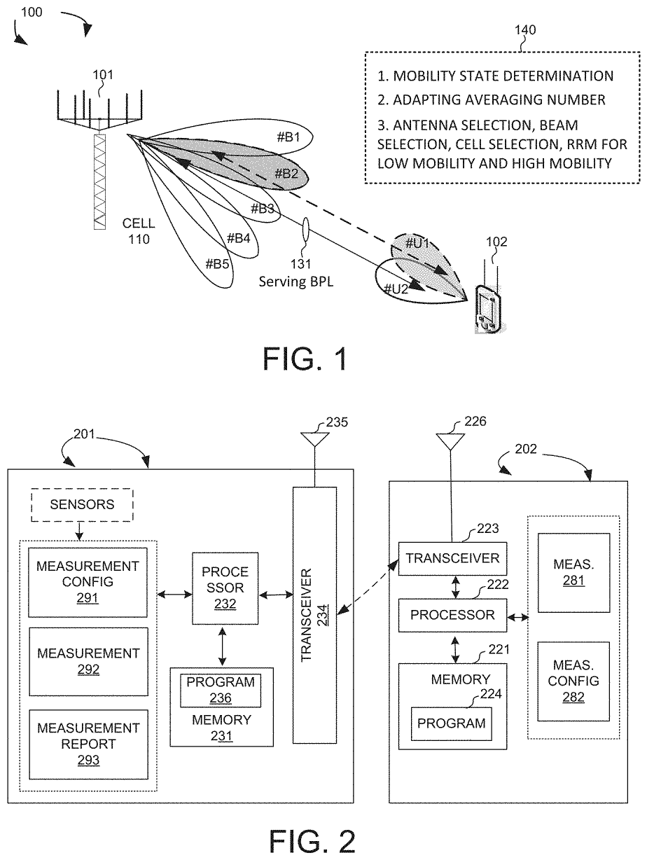

FIG. 1 illustrates a beamforming wireless communication system 100 with enhanced methods for measurement and UE antenna selection in accordance with one novel aspect. Beamforming mmWave mobile communication network 100 comprises a base station BS 101 and a user equipment UE 102. The mmWave cellular network uses directional communications with beamformed transmission and can support up to multi-gigabit data rate. Directional communications are achieved via digital and/or analog beamforming, wherein multiple antenna elements are applied with different sets of beamforming to form different beams. In the example of FIG. 1, BS 101 is directionally configured with multiple cells, and each cell is covered by a set of transmitting (TX) or receiving (RX) beams. For example, cell 110 is covered by a set of five BS beams #B1, #B2, #B3, #B4, and #B5. The collection of the BS beams #B1-#B5 covers an entire service area of cell 110. Similarly, UE 102 may be equipped with multiple antenna sets and may also apply beamforming to form multiple UE beams, e.g., #U1, #U2. For beamformed access, both ends of a link need to know which beamformers to use, e.g., a serving beam pair link (BPL) 131 needs to be established for communication between BS 101 #B3 and UE 102 #U2. An antenna set means a group of antennas.

The set of BS beams may be periodically configured or occur indefinitely and repeatedly in order known to the UEs. Each BS beam broadcasts minimum amount of cell-specific and beam-specific information similar to System Information Block (SIB) or Master Information Block (MIB) in LTE systems, or Synchronization Signal Block (SSB) in NR systems. Each BS beam may also carry UE-specific control or data traffic. Each BS beam transmits a set of known reference signals for the purpose of initial time-frequency synchronization, identification of the beam that transmits the signals, and measurement of radio channel quality for the beam that transmits the signals. Beam management and beam training mechanism, which includes both initial beam alignment and subsequent beam tracking, ensures that Base Station (BS) beam and User Equipment (UE) beam are aligned for data communication.

Reference Signal Received Power (RSRP) and Reference Signal Received Quality (RSRQ) are key measurements of signal level and quality for LTE and NR networks. In cellular networks, when a UE moves from cell to cell and performs cell selection, reselection and handover, the UE needs to measure the signal strength and quality of the neighbor cells. While a measurement of channel quality represented by Signal to Interference plus Noise Ratio (SINR) is used for link adaptation along with packet scheduling, RSRP and RSRQ are needed for making handover decisions. Received Strength Signal Indicator (RSSI) measurements can be used to determine RSRP and RSRQ. RSSI measures the average total received power observed in OFDM symbols containing reference symbols in the measurement bandwidth over certain resource blocks. RSSI is measured over the entire bandwidth including noise, serving cell power and interference power.

In accordance with one novel aspect, methods are proposed to derive a measurement result for UE antenna selection, beam selection, cell selection, handover, and radio resource management (RRM). As depicted in 140 of FIG. 1, first, UE 102 determines its mobility state by using at least two of the following metrics: 1) Doppler information including at least one of Doppler frequency shift, Doppler spread, and mobility level combining Doppler frequency shift and Doppler spread (e.g., from Mobility Detection gear, MD, estimated by a channel estimator); 2) beam ping-pong rate, beam change rate, beam change per time period; and 3) moving speed and moving direction from an accelerometer sensor, rotation speed from a gyroscope, ambient magnetic field from a magnetic field sensor, at least one active antenna set. The active antenna set means the antenna set used for transmission or reception, and an antenna set includes at least one antenna.

Moreover, moving speeds and moving directions from an accelerometer sensor, rotation speeds from a gyroscope, and ambient magnetic fields from a magnetic field sensor can be used to derive an orientation of UE 102 in an East-North-Up coordinate system or another local coordinate system. The East-North-Up coordinate system could be defined as a direct orthonormal basis where: X points east and is tangential to the ground, Y points north and is tangential to the ground, and Z points towards the sky and is perpendicular to the ground. The derivation could base on implements of rotation vector and orientation functions of Android SDK. UE 102 could further consider the orientation to determine its mobility state. UE 102 could receive at least one measurement result including at least one of RSRP, RSRQ, RSSI, IL, SNR, and SINR results from a channel estimator. Next, UE 102 uses an averaging number that is adapted based on its mobility state to derive an average measurement result including at least one of RSRP, RSRQ, RSSI, IL, SNR, and SINR. The average measurement results could be more suitable for the mobility state of UE 102. Finally, UE 102 performs antenna selection, beam selection, cell selection, or RRM based on the average measurement result and joint consideration. In a first example, for low mobility UE, the UE averages multiple RSRP or SINR results in a moving window based on the averaging number to derive an average measurement result for UE antenna selection, beam selection, cell selection, or RRM. The UE could select the antenna set or the BS beam with the best average measurement result for transmitting or receiving. In a second example, for high mobility UE, the UE applies a smaller averaging number or a joint RSRP/SINR method for UE antenna selection. The moving window means a time duration or a number of samples for moving average. In a third example, for high mobility UE, the UE uses the at least one active antenna set and the rotation angles in a period to select the UE antenna sets for another period.

FIG. 2 shows simplified block diagrams of a wireless devices, e.g., UE 201 and base station 202 in accordance with the current invention. Base station 202 has an antenna 226, which transmits and receives radio signals. A RF transceiver module 223, coupled with the antenna, receives RF signals from antenna 226, converts them to baseband signals and sends them to processor 222. RF transceiver 223 also converts received baseband signals from processor 222, converts them to RF signals, and sends out to antenna 226. Processor 222 processes the received baseband signals and invokes different functional modules to perform features in base station 202. Memory 221 stores program instructions and data 224 to control the operations of base station 202. Base station 202 also includes a set of control modules and circuits, such as a measurement circuit 281 that performs measurements and a measurement configuration circuit 282 that configures measurements resources for UEs.

Similarly, UE 201 has an antenna 235, which transmits and receives radio signals. A RF transceiver module 234, coupled with the antenna, receives RF signals from antenna 235, converts them to baseband signals and sends them to processor 232. RF transceiver 234 also converts received baseband signals from processor 232, converts them to RF signals, and sends out to antenna 235. Processor 232 processes the received baseband signals and invokes different functional modules to perform features in mobile station 201. Memory 231 stores program instructions and data 236 to control the operations of mobile station 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines.

UE 201 also includes a set of control modules and circuits that carry out functional tasks. These functions can be implemented in software, firmware and hardware. A processor in associated with software may be used to implement and configure the functional features of UE 201. For example, a measurement configuration circuit 291 configures measurement radio resources from the network. A measurement circuit 292 performs L1 and L3 measurements based on the measurement configuration. A measurement report circuit 293 transmits measurement report to the NR network for radio resource management (RRM). In addition, UE 102 may receive moving speeds, moving directions, rotation information, and ambient magnetic fields from sensors (internal or external) including a least one of an accelerometer, a gyroscope, and a magnetic field sensor to achieve better measurement results and to make better determination for antenna selection, beam selection, cell selection, and RRM.

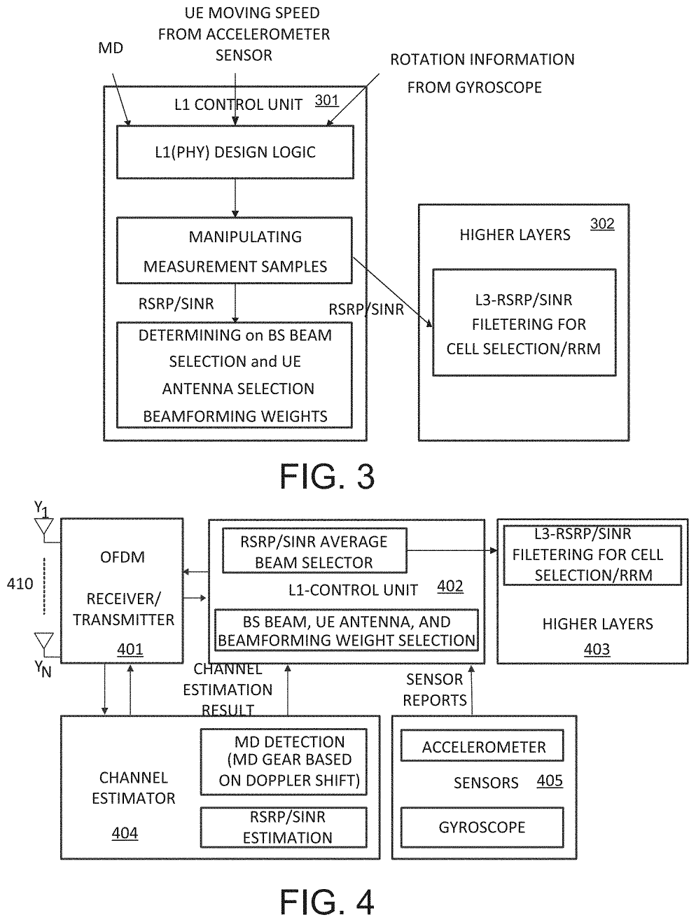

FIG. 3 illustrates methods to adjust measurement samples and determine on UE antenna selection, beam selection, cell selection, or RRM in accordance with one novel aspect. The UE has a L1 control unit 301 and a higher-layer module 302. The L1 control unit has L1 (PHY) design logic that is configured to receive Doppler information from MD, UE moving speeds from an accelerometer sensor, rotation information from a gyroscope, ambient magnetic fields from a magnetic field sensor, and other sensor reports. The measurement results are then manipulated, e.g., averaged using an adapted averaging number to derive an average measurement result, including at least one of RSRP, SINR, and etc. The average measurement result is then provided to a physical layer, a higher layer, or to its serving base station for cell selection, RRM, or handover decision. The average measurement result can also be used to determine on BS beam selection, UE antenna selection, and RX beamforming.

FIG. 4 illustrates a simplified block diagram of a UE for performing measurements and determining on UE antenna selection, beam selection, cell selection, or RRM in accordance with one novel aspect. The UE comprises a plurality of antenna sets 410, an OFDM radio signal receiver/transmitter 401, a L1 control unit 402, a higher-layer module 403, a channel estimator 404, and sensors 405. The channel estimator 404 processes radio signals received through OFDM transceiver 401 coupled to the plurality of antenna sets. Channel estimator 404 may include MD detection, e.g., MD gear based on Doppler frequency shift and Doppler spread, and RSRP/SINR estimation. Sensors 405 may include an accelerometer for providing UE moving speeds and moving directions, a gyroscope for providing UE rotation information, a magnetic field sensor for providing ambient magnetic fields, and other sensors. Measurement results from channel estimator 404 and the sensor reports from sensors 405 are then provided to the L1-control unit 402, which applies RSRP/SINR average for BS beam selection, UE antenna selection, and RX beamforming. The average measurement results, including at least one of RSRP, SINR, and etc., can also be provided to a physical layer, a higher layer module 403 for L3-RSRP/SINR filtering, or to UE's serving base station for cell selection and RRM.

One basic design concept is to consider MD from channel estimation for beam selection, cell selection, or RRM. For channel estimation, a UE uses CRS/PSS/SSS/CSI-RS to estimate and trace the channel between the UE and the serving base stations. The channel estimation could include Mobility Detection Gears (MD) indicating Doppler frequency shift and spread levels corresponding to different channel path/carrier frequency. MD could consider Doppler spread and frequency shift between the UE and the serving base stations, and could be used to determine a mobility level. For example, if a UE estimate Doppler spread or frequency shift larger than a threshold, then the corresponding MD could be a higher mobility level. If a UE estimate Doppler spread and frequency shift smaller than a threshold, then the corresponding MD could be a lower mobility level. The UE could average multiple RSRP measurement results from a channel estimator and use the average RSRP measurement result for beam selection, cell selection, or RRM, if the Doppler frequency shift level is lower than a predefined value X (low mobility level). If the Doppler frequency shift levels is equal to or higher than the predefined value X (high mobility level), then the UE could average one or few number of RSRP measurement results.

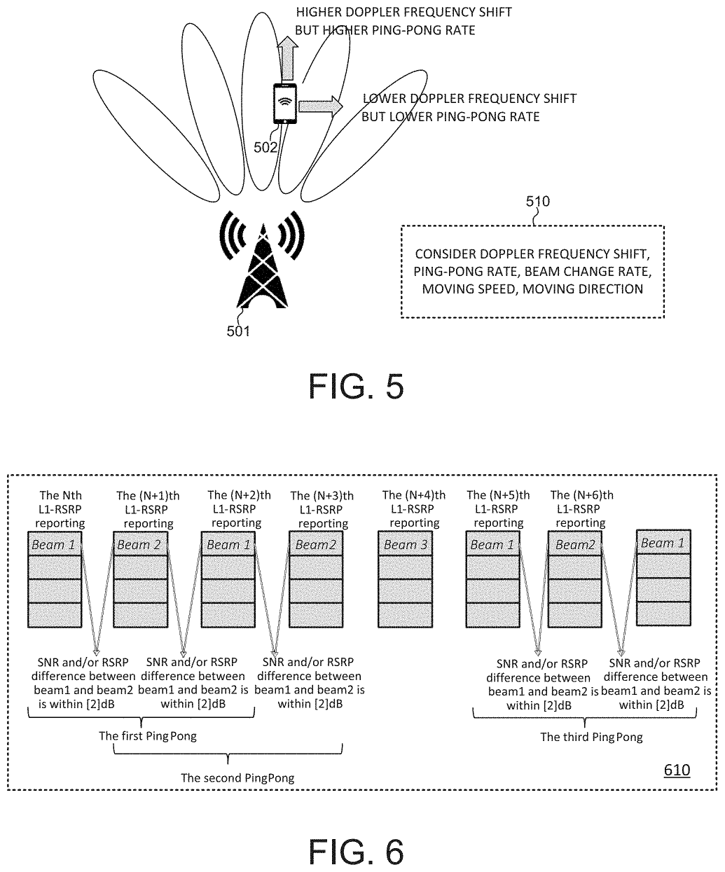

FIG. 5 illustrates certain issues with applying Doppler frequency shift to average RSRP measurement results and methods for improvement. In the example of FIG. 5, UE 502 with beamforming is served by its serving base station 501. It can be seen that when UE 502 moves upward, it may have higher Doppler frequency shift but higher Ping-Pong rate. When UE 502 moves sideward, it may have lower Doppler frequency shift but lower Ping-Pong rate. As a result, the basic design concept, as depicted by 510, is that the averaging of RSRP or other measurement results can be based on joint consideration of a Doppler frequency shift level, a Doppler spread, a ping-pong rate, a beam change rate, antenna selection results, a UE speed, and a moving direction. For example, if a UE estimate Doppler spread smaller than a threshold and Doppler frequency shift smaller than another threshold, then the corresponding MD could be a lower mobility level.

FIG. 6 illustrates one embodiment of beam selection, cell selection, or RRM using MD plus beam Ping-Pong rate. In one novel aspect, in addition to the Doppler frequency shift level, the UE can further consider the beam Ping-Pong Rate as depicted by box 610, to average the L1-RSRP for beam selection, cell selection, or RRM. PingPong in beam measurement and reporting means that the best beam of the first beam report of a UE changes to others and then changes back to the best beam of the first report during a period. In the example of 610, a UE reports 8 Ll-RSRP reports from the N-th RSRP report to the (N+7) L1-RSRP report in order. The N-th RSRP report indicates that Beam 1 is the best beam, and the (N+1)-th RSRP report indicates that Beam 2 is the best beam, and then (N+2)-th RSRP report indicates that Beam 1 is the best beam again. This is a PingPong for beam management and reporting. The (N+1)-th, (N+2)-th, and (N+3) RSRP reports show the same situation. PingPong change per second could be defined to be the PingPong number divided by the time length, and PingPong change rate could be defined to be the PingPong number divided by the beam report number during a time unit. In addition, PingPong could further consider one of SNR, SINR, and RSRP. If the differences of SNR, SINR, and RSRP of the (N+1)-th, (N+2)-th, and (N+3) RSRP reports are larger than a threshold, the PingPong could be regarded as exception or normal beam change. In one example, a UE could estimate the Doppler frequency shift levels between the UE and the serving base stations and the Ping-Pong rate of the used BS beam, and then the UE could average multiple RSRP measurement results from a channel estimator and use the average RSRP measurement results for beam selection, cell selection, or RRM, if MD is lower than X and/or Ping-Pong Rate is larger than Y %. Moreover, a PingPong may be defined by that the best beam of the first RSRP/SINR measurement result from a channel estimator changes to others and then changes back to the best beam of the first RSRP/SINR measurement result during a period.

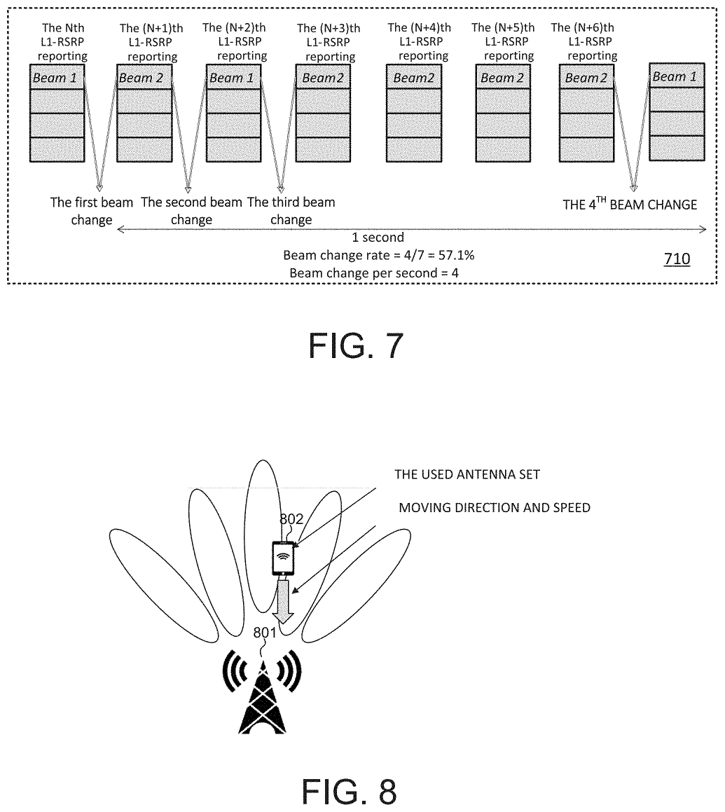

FIG. 7 illustrates one embodiment of beam selection, cell selection, or RRM using MD plus beam change rate. In another novel aspect, in addition to the Doppler frequency shift level, the UE can further consider the beam change rate or beam change per time period as depicted by 710, to average RSRP measurement results from a channel estimator for beam selection, cell selection, or RRM. In the example of 710, beam change per second could be defined to be the beam change number divided by the time length, and beam change rate could be defined to be the beam change number divided by the beam report number during a time unit. In one example, a UE could estimate the Doppler frequency shift levels between the UE and the serving base stations and the beam change rate, and then the UE could average multiple RSRP measurement results from a channel estimator if MD is lower than X and/or beam change rate is larger than Y % (and/or beam change per second is larger than Z). For beam selection, averaging multiple RSRP measurement results could reduce the beam PingPong rate or estimation error.

FIG. 8 illustrates embodiments of beam selection and cell selection using MD plus UE antenna selection, UE speed, and moving direction. By considering UE antenna selection and moving direction from accelerometer sensors, the UE could identify that it could be moving towards, backwards, or around the serving base station. The UE could average multiple RSRP measurement results for beam selection, cell selection, or RRM if MD is smaller than X and/or the UE is moving towards or backwards the serving base station. As illustrated in FIG. 8, for example, the at least one active antenna set usually face the serving base station 801. If the moving direction of UE 802 is same as the main lobe of the at least one active antenna set, UE 802 could identify that it could be moving towards or backwards the serving base station. The used BS beam could be stable, so UE 802 could use average multiple RSRP measurement results for beam selection, cell selection, or RRM. If the moving direction of UE 802 is not same as the main lobe of the at least one active antenna set, UE 802 could identify that it could be moving around the serving base station, then UE 802 could average one or few number of RSRP measurement results. Further, UE 802 could integrate with accelerometer sensors or get UE moving speed reports from an accelerometer sensor. Based on the UE moving speed reports, UE 802 could average multiple RSRP measurement results for beam selection, cell selection, or RRM if the average UE moving speed of a period or the last UE moving speed is lower than X km/hour with low mobility.

For antenna selection from multiple antenna sets, a UE could estimate RSRP/SINR and find the at least one best antenna set with the at least one best RSRP. If the RSRP difference is less than Z dB, then the UE could further use SINR to select the at least one best antenna set for transmitting (TX) or receiving (RX). A UE could apply one of joint-RSRP/SINR methods for UE antenna selection. The joint-RSRP/SINR methods includes: Proposal 1 (P1): mainly use RSRP>X dBm and SINR>Y dB, e.g., find the at least one best antenna set with the at least one best RSRP>X dBm and SINR>Y dB. Proposal 2 (P2): mainly use RSRP>X dBm. If RSRP difference between the best two antenna sets with the best RSRPs is less than Y dB, further use SINR to select at least one antenna set, e.g., find the at least one best antenna set with the at least one best RSRP. If the RSRP difference is less than Y dB, further use SINR to select the at least one best antenna set with at least one best SINR in the best two antenna sets with the best RSRPs. Proposal 3 (P3): mainly use SINR>X dB. If SINR difference between the best two antenna sets with the best SINRs is less than Y dB, further use RSRP to select at least one antenna set, e.g., find the at least one best antenna set with the at least one best SINR. If the SINR difference is less than Y dB, further use RSRP to select the at least one best antenna set with at least one best RSRP in the best two antenna sets with the best SINRs. Proposal 4 (P4): use an average SINR or RSRP for antenna selection if a rotation speed from a gyroscope is low. A moving direction from an accelerometer sensor and a rotation speed from a gyroscope can also be considered to select at least one antenna set and RX beamforming configuration, or determine whether a UE is low or high mobility for using average SINR or RSRP.

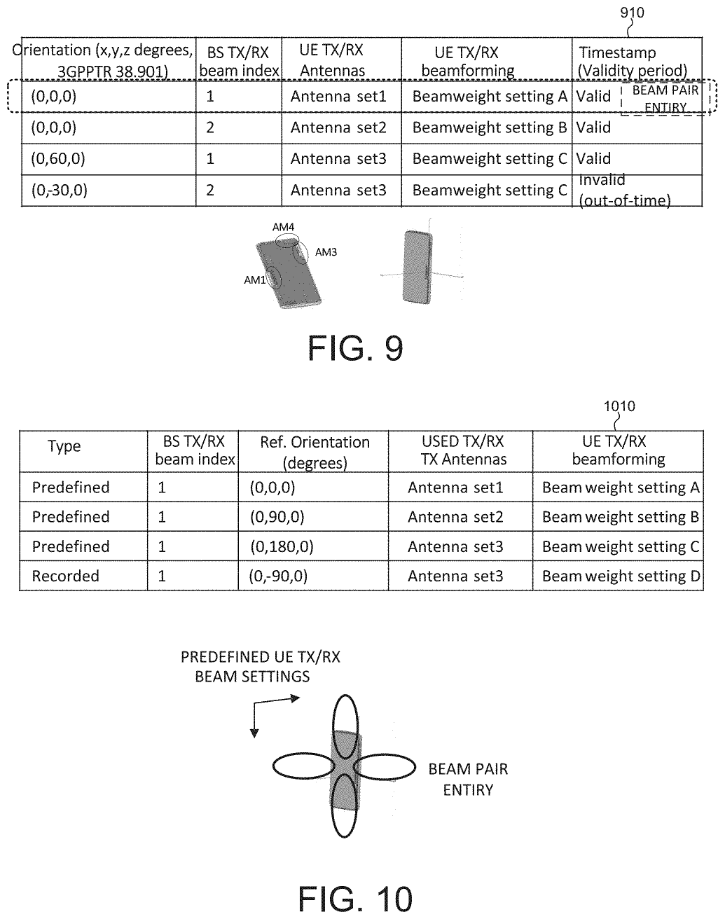

FIG. 9 illustrates a first embodiment of antenna selection using UE moving speeds from an accelerometer sensor and orientations derived from at least two of moving speeds and moving directions from an accelerometer sensor, rotation speeds from a gyroscope, and ambient magnetic fields from a magnetic field sensor. A UE could record the UE TX or RX beamforming configuration and the at least one active antenna set for BS beams with the corresponding UE orientation, as depicted by 910, and could use one of the recorded UE TX or RX beamforming and the at least one active antenna set when the orientation is changed. The UE could use a longer period for RSRP estimation and/or UE TX or RX beamforming configuration update, if the UE moving speed from an accelerometer sensor or MD is lower than a threshold. The UE could use a short period for RSRP estimation and/or Rx beam update, if the UE moving speed from an accelerometer sensor or MD is higher than a threshold.

The UE could record a number of BS beams and the corresponding information. In one example, a UE may be used for reading, so the UE orientation is stable. The UE could directly use at least one of the recorded UE TX or RX beamforming configurations when the orientation is changed. In the example of FIG. 9, if the newest orientation is close to (0,0,0), then the UE could use the Beam weight setting A for BS TX or RX beam 1 and use the Beam weight setting B for BS TX or RX beam 2. The beam weight setting is a beamforming configuration to coordinate multiple antenna elements to form an antenna port for TX or RX.

FIG. 10 illustrates a second embodiment of antenna selection using UE moving speed from accelerometer sensor and orientations derived from at least two of moving speeds and moving directions from an accelerometer sensor, rotation speeds from a gyroscope, and ambient magnetic fields from a magnetic field sensor. A UE could have predefine UE RX/TX beamforming configurations and the at least one active antenna set with the corresponding orientation, and record UE TX or RX beamforming configurations and the at least one active antenna set with the corresponding UE orientations for BS beams, as depicted by 1010. The UE could use one of the predefined and the recorded UE TX or RX beamforming configurations and the at least one active antenna set when the orientation is changed. The UE could use a longer period for RSRP estimation or Rx beam update, if the UE moving speed from an accelerometer sensor or MD is lower than a threshold. On the other hand, the UE could use a short period for RSRP estimation or Rx beam update, if the UE moving speed from an accelerometer sensor or MD is higher than a threshold.

Reference orientation could be defined as orientation in a predefined orientation system, except the East-North-Up coordinate system. For example, the orientation of the phone main screen is (0,0,0) and the orientation of the phone back cover is (0,180,0). Orientation change is defined as difference between two measured orientations (Ref 3GPP TR38.901 Section 7.1 Coordinate System). A suitable beam pair entry with the closest reference orientation to the previous reference orientation plus the orientation change can be found. In one example, the last reference orientation is (0, 0, 0). The last recorded beam pairs with best L1-RSRP or SINR is close to the beam pair entry “Antenna set1, Beam weight setting A” in table 910 and the orientation is changed from (30, 30, 30) to (30, 120, 30), so the orientation change is (0, 90, 0) and the UE could use the beam pair entry (Antenna set2, Beam weight setting B) due to “(0, 0, 0)+(0, 90, 0)=(0, 90, 0)”. (Previous reference orientation+Orientation shift change=Next reference orientation). In another example, the last reference orientation is (0, 0, 0). The last recorded beam pairs with best L1-RSRP or SINR is close to the beam pair entry “Antenna set2, Beam weight setting B” in the below table and the orientation is changed from (30, 30, 30) to (30, −60, 30), so the orientation change is (0, −90, 0) and the UE could use the beam pair entry (Antenna set1, Beam weight setting A) due to “(0, 90, 0)+(0, −90, 0)=(0, 0, 0)”.

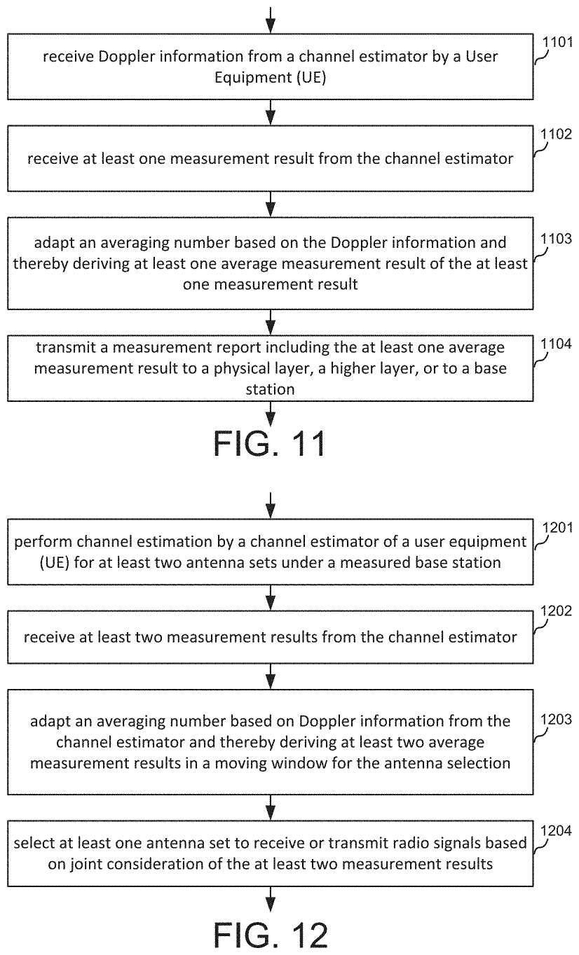

FIG. 11 is a flow chart of a method for UE beam selection, cell selection, or RRM in accordance with one novel aspect. In step 1101, a UE receives Doppler information from a channel estimator of the UE. In step 1102, the UE receives at least one measurement result from the channel estimator. In step 1103, the UE adapts an averaging number based on the Doppler information and thereby derives an average measurement result of the at least one measurement result in a moving window. The moving window means a time duration or a number of samples, and it can be used for simple moving average, weighted moving average, exponential moving average, and other average methods. In step 1104, the UE transmits a measurement report including the average measurement result to a physical layer, a higher layer, such as Layer-2 and Layer-3, or to a serving base station of the UE. Layer-1 in a protocol stack, such as NR user plane protocol stack and NR control plane protocol stack, may include a physical layer. Layer-2 and Layer-3 may include Packet Data Convergence Protocol (PDCP), Radio Link Control (RLC), Medium Access Control (MAC), and Radio Resource Control (RRC) layers.

FIG. 12 is a flow chart of a method for UE antenna selection in accordance with one novel aspect. In step 1201, a UE performs channel estimation by a channel estimator of the UE for at least two antenna sets under a measured base station. In step 1202, the UE receive at least two measurement results from the channel estimator. The at least two measurement results could be selected at least two from RSRP, RSRQ, RSSI, LI, SNR, and SINR, and may include the respective values of RSRP, RSRQ, RSSI, LI, SNR, and SINR of the at least two antenna sets. In step 1203, the UE adapts an averaging number based on Doppler information from the channel estimator and thereby derives at least two average measurement results of the at least two measurement results in a moving window. In step 1204, the UE selects at least one antenna set to receive or transmit radio signals based on joint consideration of the at least two average measurement results.

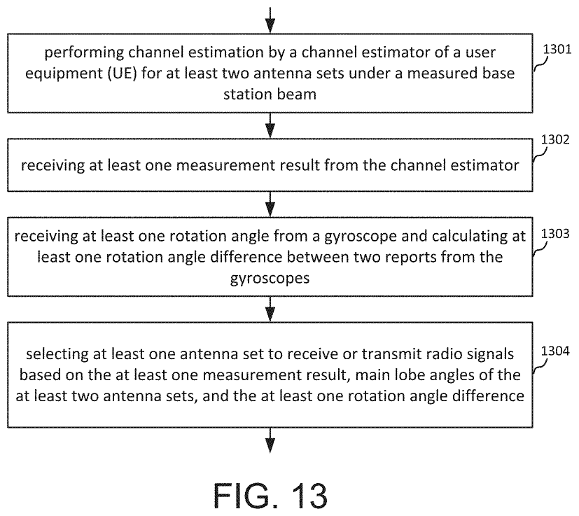

FIG. 13 is a flow chart of a method for UE antenna selection in accordance with one novel aspect. In step 1301, a UE performs channel estimation by a channel estimator of the UE for at least two antenna sets under a measured base station beam. In step 1302, the UE receives at least two measurement results of the at least two antenna sets. In step 1303, the UE receives at least one rotation angle from a gyroscopes and calculating at least one rotation angle difference between two reports from the gyroscope. In step 1304, the UE selects at least one antenna set to receive or transmit radio signals based on the at least two measurement results of the at least two antenna sets, the main lobe angles of the at least two antenna sets, and the at least one rotation angle difference.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving Doppler information from a channel estimator by a User Equipment (UE);
receiving at least one measurement result from the channel estimator;
adapting an averaging number based on the Doppler information and thereby deriving at least one average measurement result of the at least one measurement result; and
transmitting a measurement report including the at least one average measurement result to a physical layer, a higher layer, or to a base station.

2. The method of claim 1, wherein the at least one measurement result is selected from a Reference Signal Received Power (RSRP), a Reference Signal Received Quality (RSRQ), a Received Signal Strength Indicator (RSSI), an Interference Level (IL), a Signal to Noise Ratio (SNR), and a Signal to Interference plus Noise Ratio (SINR).

3. The method of claim 1, wherein the Doppler information comprises at least one of Doppler frequency shift, Doppler spread, and a mobility level combining Doppler frequency shift and Doppler spread.

4. The method of claim 3, wherein the averaging number is adapted to be decreased when the at least one of Doppler frequency shift, Doppler spread, and a mobility level is increased.

5. The method of claim 1, further comprising:
receiving a moving speed and a moving direction from an accelerometer sensor to be used for the averaging number adaptation.

6. The method of claim 1, further comprising:
receiving a rotation speed from a gyroscope and using the rotation speed to be used for the averaging number adaptation.

7. The method of claim 1, wherein the averaging number is further adapted based on at least one of a moving speed, a rotation speed, a beam Ping-Pong rate, a beam change rate, an antenna selection, and a moving direction.

8. A method comprising:
performing channel estimation by a channel estimator of a User Equipment (UE) for at least two antenna sets under a measured base station;
receiving at least two measurement results from the channel estimator; and
selecting at least one antenna set to receive or transmit radio signals based on joint consideration of the at least two measurement results.

9. The method of claim 8, wherein the at least two measurement results are selected from a Reference Signal Received Power (RSRP), a Reference Signal Received Quality (RSRQ), a Received Signal Strength Indicator (RSSI), an Interference Level (IL), a Signal to Noise Ratio (SNR), and a Signal to Interference plus Noise Ratio (SINR).

10. The method of claim 9, wherein the joint consideration comprises at least one of the antenna sets with at least one of RSRP, RSRQ, SNR, and SINR is higher than a first predefined threshold, or with at least one of RSSI and IL is lower than a second predefined threshold.

11. The method of claim 8, further comprising:
adapting an averaging number based on Doppler information from the channel estimator and thereby deriving at least two average measurement results in a moving window for the antenna set selection.

12. The method of claim 11, further comprising:
receiving a moving speed and a moving direction from an accelerometer sensor to be used for the averaging number adaptation.

13. The method of claim 11, further comprising:
receiving a rotation speed from a gyroscope and using the rotation speed to be used for the averaging number adaptation.

14. The method of claim 11, wherein the averaging number is further adapted based on at least one of a moving speed, a rotation speed, a beam Ping-Pong rate, a beam change rate, an antenna selection, and a moving direction.

15. A method comprising:
performing channel estimation by a channel estimator of a user equipment (UE) for at least two antenna sets under a measured base station beam;
receiving at least one measurement result from the channel estimator;
receiving at least one rotation angle from a gyroscope and calculating at least one rotation angle difference between two reports from the gyroscope; and
selecting at least one antenna set to receive or transmit radio signals based on the at least one measurement result, main lobe angles of the at least two antenna sets, and the at least one rotation angle difference.

16. The method of claim 15, wherein the at least one measurement result is selected from a Reference Signal Received Power (RSRP), a Reference Signal Received Quality (RSRQ), a Received Signal Strength Indicator (RSSI), an Interference Level (IL), a Signal to Noise Ratio (SNR), and a Signal to Interference plus Noise Ratio (SINR).

17. The method of claim 15, wherein the at least one antenna set is selected based on main lobe angles of at least one selected antenna set of a previous selection, the main lobe angles of the at least two antenna sets, and the at least one rotation angle difference.

18. The method of claim 15, wherein the at least one antenna set is selected based on having at least one of RSRP, RSRQ, SNR, and SINR higher than a first predefined threshold, or having at least one of RSSI and IL lower than a second predefined threshold.

19. The method of claim 15, further comprising:
receiving a moving speed and a moving direction from an accelerometer sensor.

20. The method of claim 19, wherein the UE uses a longer period for receiving the at least one rotation angle from the gyroscope or performing channel estimation when the moving speed is lower than a threshold, and uses a shorter period for receiving the at least one rotation angle from the gyroscope or performing channel estimation when the moving speed is higher than the threshold.
